(19) United States
(12) Patent Application Publication
(10) Pub. No.: US 2010/0238374 A1
(43) Pub. Date: Sep. 23, 2010

(54) FIBER LAMP, BACKLIGHT AND LIQUID CRYSTAL DISPLAY

(75) Inventor: Norihiro Ohse, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/717,395

(22) Filed: Mar. 4, 2010

(30) Foreign Application Priority Data
Mar. 18, 2009 (JP) 2009-066872

(51) Int. Cl. G02F 1/1335; G02B 6/00; H01S 3/00; G02F 1/13357

(52) U.S. Cl. 349/61; 362/551; 362/553; 362/97.1

(57) ABSTRACT

A fiber lamp allowed to reduce an influence of heat, a backlight and a liquid crystal display both using the fiber lamp are provided. A fiber lamp includes: a side-emitting fiber including a core layer guiding light and a cladding layer arranged around the core layer, the cladding layer allowing light to be extracted from a surface of the cladding layer; a light source arranged on one or both of a pair of end surfaces of the side-emitting fiber and emitting single-color light; and a phosphor layer arranged on the surface of the cladding layer and including a red phosphor and a green phosphor.

### CROSS REFERENCES TO RELATED APPLICATIONS

The present application claims priority to Japanese Priority Patent Application JP 2009-066872 filed in the Japan Patent Office on Mar. 18, 2009, the entire content of which is hereby incorporated by references.

### BACKGROUND

The present application relates to a fiber lamp suitable for a backlight for liquid crystal, and a backlight and a liquid crystal display each including the fiber lamp.

White LEDs (Light Emitting Diodes) including a blue LED and a phosphor to emit white light have been developed, and have been used for various applications such as a backlight for liquid crystal television and illumination as described in, for example, International Publication No. WO98/05078.

Moreover, edge-light type backlights are known mainly as backlights for small displays. In the edge-light type backlights, for example, as described in Japanese Unexamined Patent Application Publication No. 2007-53021, LEDs are arranged on a side surface of a light guide plate, and light enters from the side surface of the light guide plate to propagate through the light guide plate, and then the light is extracted from a top surface of the light guide plate.

### SUMMARY

However, in white LEDs in related art, a phosphor is arranged close to an LED as a heat source, so the phosphor deteriorates due to an influence of heat.

Moreover, in edge-light type backlights, LEDs concentrated on a side surface of a light guide plate generate a large amount of heat, so the large amount of heat causes an issue in reliability of a light guide plate made of plastic. In particular, when the edge-light type backlight is upsized, the LEDs need considerably high luminance, so heat is a serious issue.

It is desirable to provide a fiber lamp allowed to reduce an influence of heat, and a backlight and a liquid crystal display each using the fiber lamp.

According to an embodiment, there is provided a first fiber lamp including: a side-emitting fiber including a core layer guiding light and a cladding layer arranged around the core layer, the cladding layer allowing light to be extracted from a surface of the cladding layer; a light source arranged on one or both of a pair of end surfaces of the side-emitting fiber and emitting single-color light; and a phosphor layer arranged on the surface of the cladding layer and including a red phosphor and a green phosphor.

According to an embodiment, there is provided a second fiber lamp including: a side-emitting fiber including a core layer guiding light and a cladding layer arranged around the core layer, the cladding layer including a red phosphor and a green phosphor and allowing light to be extracted from a surface of the cladding layer; and a light source arranged on one or both of a pair of end surfaces of the side-emitting fiber and emitting single-color light.

According to an embodiment, there are provided a first backlight and a second backlight including: a diffuser plate; and a fiber lamp arranged on a back surface of the diffuser plate, in which the fiber lamp is configured of the first fiber lamp and the second fiber lamp according to the above-described embodiment, respectively.

According to an embodiment, there are provided a third backlight and a fourth backlight including: a light guide plate and a fiber lamp arranged on a side surface of the light guide plate, in which the fiber lamp is configured of the first fiber lamp and the second fiber lamp according to the above-described embodiment, respectively.

According to an embodiment, there are provided first to fourth liquid crystal displays including a liquid crystal display panel; and a backlight, in which the backlight is configured of the first to the fourth backlights according to the above-described embodiment, respectively.

In the first fiber lamp according to the embodiment, single-color light from the light source enters from an end surface of the side-emitting fiber, and is guided into the core layer to be extracted from the surface of the cladding layer. At this time, the light enters into the phosphor layer arranged on the surface of the cladding layer, and a part of the incident light is converted into another color light by the red phosphor and the green phosphor included in the phosphor layer. Thereby, color light which passes through the phosphor layer without being converted into another color light and color light converted by the phosphor layer are mixed, so that, for example, white light is obtainable.

In the second fiber lamp according to the embodiment, single-color light from the light source enters from an end surface of the side-emitting fiber, and is guided into the core layer to be extracted from the cladding layer. At this time, a part of incident light into the cladding layer is converted into another color light by the red phosphor and the green phosphor included in the cladding layer. Thereby, color light which passes through the phosphor layer without being converted into another color light and color light converted by the phosphor layer are mixed, so that, for example, white light is obtainable.

In the first fiber lamp according to the embodiment, the light source is arranged on one or both of the pair of end surfaces of the side-emitting fiber, and the phosphor layer including the red phosphor and the green phosphor is arranged on the surface of the cladding layer of the side-emitting fiber, so the phosphor layer is separated from the light source which generates heat, so that a reduction in an influence of heat is allowed. Therefore, when a backlight or a liquid crystal display is formed using the fiber lamp, a possibility that heat causes an issue in reliability of the diffuser plate, the light guide plate or the like is allowed to be reduced, and the fiber lamp is also suitable for upsizing.

In the second fiber lamp according to the embodiment, the light source is arranged on one or both of the pair of end surfaces of the side-emitting fiber, and the red phosphor and the green phosphor are included in the cladding layer of the side-emitting fiber, so the cladding layer including the phosphors is separated from the light source which generates heat, so that a reduction in the influence of heat is allowed. Therefore, when a backlight or a liquid crystal display is formed using the fiber lamp, a possibility that heat causes an issue in reliability of the diffuser plate, the light guide plate or the like is allowed to be reduced, and the fiber lamp is also suitable for upsizing.

Additional features and advantages are described herein, and will be apparent from the following Detailed Description and the figures.

### BRIEF DESCRIPTION OF THE FIGURES

FIG. 1 is an illustration of the whole configuration of a fiber lamp according to an embodiment.

FIG. 2 is a sectional view of a configuration of a side-emitting fiber illustrated in FIG. 1.

FIG. 3 is a sectional view of another configuration of the side-emitting fiber illustrated in FIG. 1.

FIG. 4 is an illustration of another configuration of the fiber lamp illustrated in FIG. 1.

FIG. 5 is an illustration of still another configuration of the fiber lamp illustrated in FIG. 1.

FIG. 6 is an illustration of a further configuration of the fiber lamp illustrated in FIG. 1.

FIG. 7 is an illustration of a configuration of a backlight including the fiber lamp illustrated in FIG. 1.

FIG. 8 is an illustration of another configuration of the backlight including the fiber lamp illustrated in FIG. 1.

FIG. 9 is an illustration of another configuration of the backlight illustrated in FIG. 8.

FIG. 10 is an illustration of still another configuration of the backlight including the fiber lamp illustrated in FIG. 1.

FIGS. 11A and 11B are illustrations of a further configuration of the backlight including the fiber lamp illustrated in FIG. 1.

FIG. 12 is an illustration of a still further configuration of the backlight including the fiber lamp illustrated in FIG. 1.

FIG. 13 is an illustration of the whole configuration of a liquid crystal display.

FIG. 14 is an illustration of a still further configuration of the fiber lamp.

FIG. 15 is an illustration of a still configuration of the fiber lamp.

### DETAILED DESCRIPTION

The present application will be described in detail below referring to the accompanying drawings, according to an embodiment. Descriptions will be given in the following order.

(1) Fiber Lamp

(2) Backlight

(3) Liquid Crystal Display

Fiber Lamp

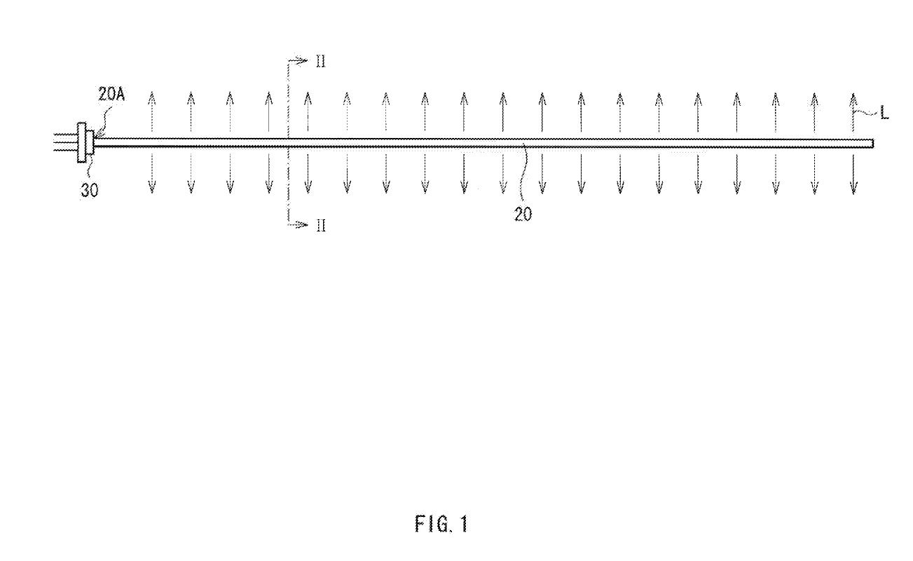

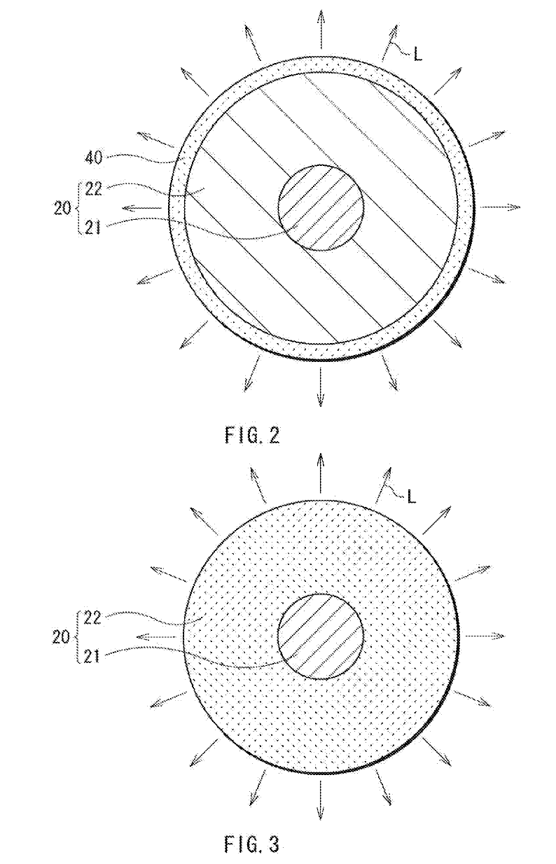

FIG. 1 illustrates the whole configuration of a fiber lamp according to an embodiment, and FIG. 2 illustrates an example of a sectional configuration taken along a line II-II of FIG. 1. The fiber lamp 10 is formed by arranging a light source 30 on one end surface 20A of a side-emitting fiber 20. The side-emitting fiber 20 includes a cladding layer 22 around a core layer 21, and light L from the light source 30 is guided into the core layer 21, and then the light L is uniformly extracted from the whole surface of the cladding layer 22. A phosphor layer 40 is arranged on the surface of the cladding layer 22. The phosphor layer 40 includes a phosphor converting incident color light into color light in a longer wavelength region, more specifically, the phosphor layer 40 includes at least a red phosphor and a green phosphor. Thereby, in the fiber lamp 10, the phosphor layer 40 is separated from the light source 30 which generates heat, so that a reduction in an influence of heat is allowed.

The light source 30 emits single-color light, and is configured of, for example, a laser or an LED. In the case where the diameter of the side-emitting fiber 20 is 1 mm or less, the laser is preferable. The light source 30 is configured of, for example, a laser having an oscillation wavelength in a blue region (for example, 445 nm) or a laser having an oscillation wavelength in a violet region (for example, 405 nm).

In the case where the light source 30 is a laser having an oscillation wavelength in a blue region, the phosphor layer 40 includes a red phosphor and a green phosphor. In the case where the light source 30 is a laser having an oscillation wavelength in a violet region, the phosphor layer 40 includes a red phosphor, a green phosphor and a blue phosphor.

Phosphors converting incident light into green include SrGa₂S₄:Eu²⁺, Ca₃Sc₂Si₃O₁₂:Ce³⁺ and the like. Phosphors converting incident light into red include (Ca, Sr, Ba)S:Eu²⁺, (Ca, Sr, Ba)₂Si₅N₈:Eu²⁺, CaAlSiN₃:Eu²⁺ and the like. Moreover, violet-excitable phosphors converting incident light into blue include Sr₅(PO₄)₃Cl:Eu²⁺ and the like. Such a phosphor layer 40 is formable by directly applying a solvent mixed with the above-described phosphors to the surface of the cladding layer by printing or coating, and then drying the solvent. Alternatively, the phosphor layer 40 is also formable by kneading a material such as ethyl cellulose, a silicone resin, an acrylic resin or an epoxy resin with the above-described phosphors, and then coating the surface of the cladding layer 22 with the material.

FIG. 3 illustrates another example of the sectional configuration of the side-emitting fiber 20. The side-emitting fiber 20 does not include the phosphor layer 40, and includes at least a red phosphor and a green phosphor in the cladding layer 22. In this case, when the side-emitting fiber 20 is formed, a constituent material of the cladding layer 22 is kneaded with phosphor materials, thereby the side-emitting fibers 20 are collectively manufacturable.

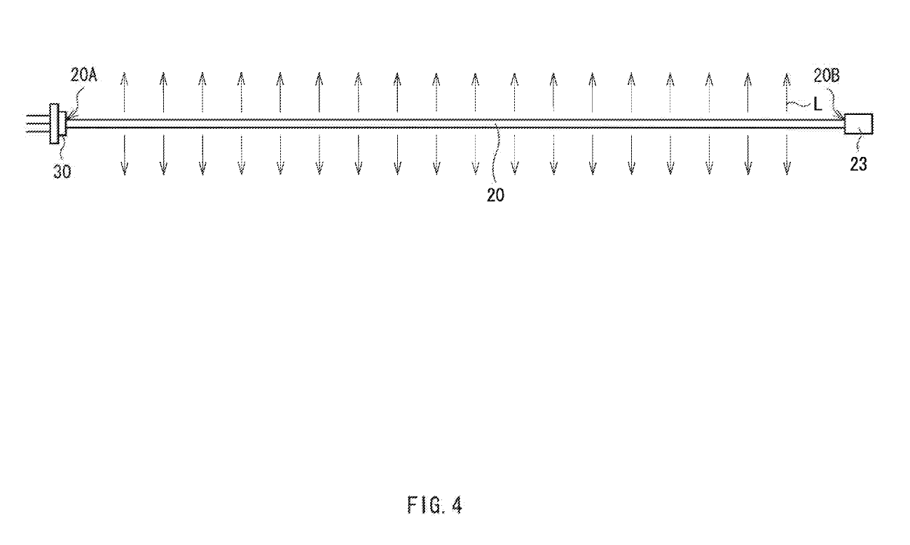

In such a fiber lamp 10, for example, as illustrated in FIG. 4, the other end surface 20B of the side-emitting fiber 20 is preferably subjected to a mirror process so that an mirror 23 is arranged on the end surface 20B, because the uniformity of the fiber lamp 10 as a line light source is allowed to be further enhanced.

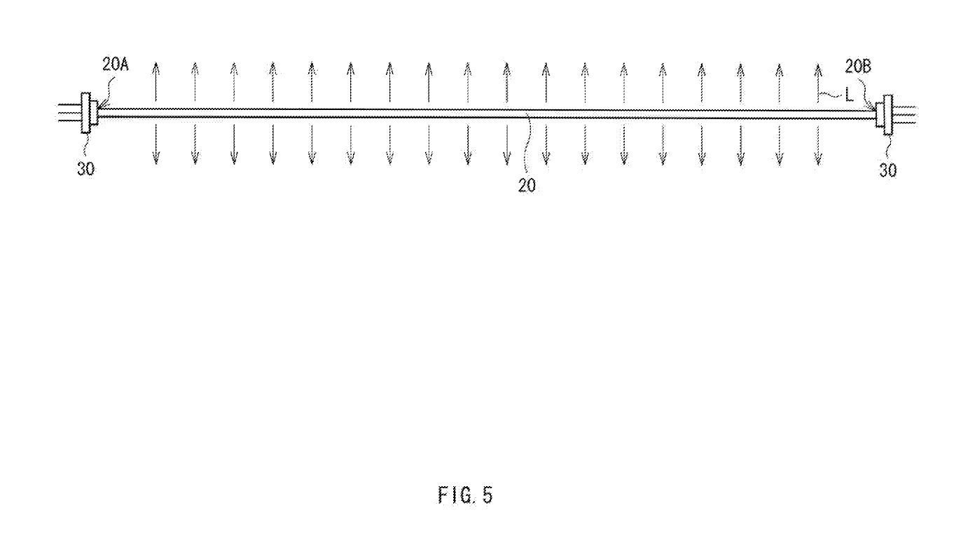

Moreover, in the fiber lamp 10, for example, as illustrated in FIG. 5, the light sources 30 may be arranged on both of the end surfaces 20A and 20B of the side-emitting fiber 20. Thereby, the brightness of light extracted from the surface of the cladding layer 22 is allowed to be doubled.

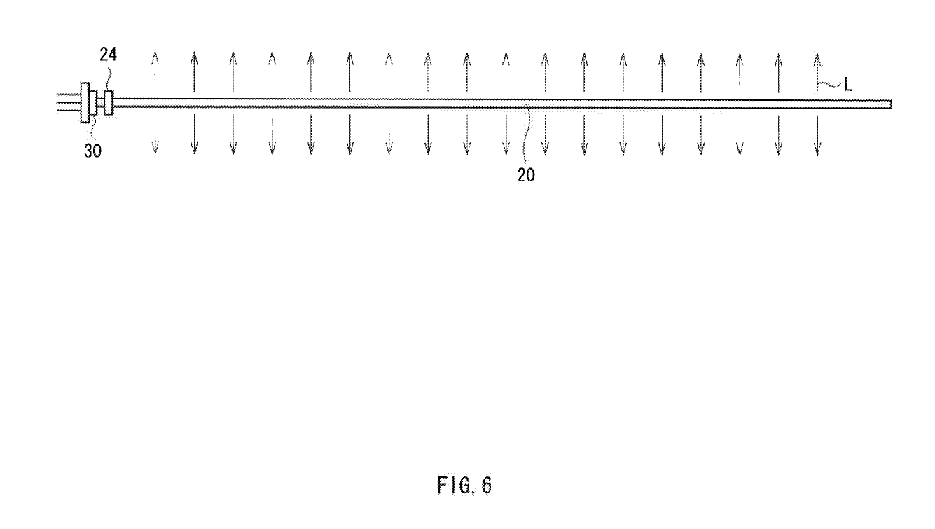

Further, in the fiber lamp 10, specifically in the case where a laser is used as the light source 30, for example, as illustrated in FIG. 6, an oscillator 24 is preferably arranged on the side-emitting fiber 20 to eliminate speckle noise unique to the laser. The oscillator 24 is configured of, for example, a piezoelectric element, a magnetostriction element or the like.

In the fiber lamp 10 illustrated in FIG. 2, the single-color light L from the light source 30 is guided into the core layer 21 of the side-emitting fiber 20 to be extracted from the surface of the cladding layer 22. At this time, light enters into the phosphor layer 40 arranged on the surface of the cladding layer 22, and a part of the incident light is converted into another color light by the red phosphor and the green phosphor included in the phosphor layer 40. Thereby, color light which passes through the phosphor layer 40 without being converted into another color light and color light converted by the phosphor layer 40 are mixed, so that, for example, white light is obtainable.

In the fiber lamp 10 illustrated in FIG. 3, the single-color light L from the light source 30 is guided into the core layer 21 of the side-emitting fiber 20 to be extracted from the surface of the cladding layer 22. At this time, a part of light entering into the cladding layer 22 is converted into another color light by the red phosphor and the green phosphor included in the cladding layer 22. Thereby, color light which is passes through the cladding layer 22 without being converted into another color light and color light converted by the cladding layer 22 are mixed, so that, for example, white light is obtainable.

At this time, in both of the fiber lamps 10 illustrated in FIG. 2 and FIG. 3, heat is generated only from the light source 30, and a heat load is hardly applied to the phosphor layer 40 or the cladding layer 22 including the phosphors in the side-emitting fiber 20, and only a light load is applied to them. Therefore, the influence of heat is reduced, thereby the longevities of the phosphors are allowed to be increased, or the phosphors are usable with higher luminance without reducing their longevities.

Thus, in the fiber lamp 10 according to the embodiment, the light source 30 is arranged on the end surface 20A of the side-emitting fiber 20, and the phosphor layer 40 including at least the red phosphor and the green phosphor is arranged on the surface of the cladding layer 22 of the side-emitting fiber 20, so the phosphor layer 40 is separated from the light source 30 which generates heat, so that a reduction in the influence of heat is allowed.

Moreover, in the another fiber lamp 10 according to the embodiment, the light source 30 is arranged on the end surface 20A of the side-emitting fiber 20, and the cladding layer 22 of the side-emitting fiber 20 includes at least the red phosphor and the green phosphor, so the cladding layer 22 including the phosphors is separated from the light source 30 which generates heat, so that a reduction in the influence of heat is allowed.

Backlight; Back Surface Arrangement

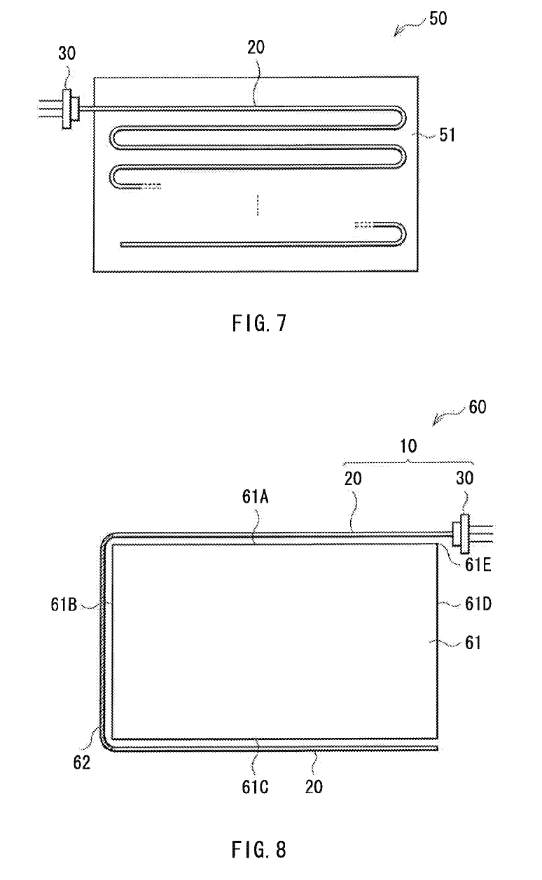

FIG. 7 illustrates a configuration of a backlight 50 using the fiber lamp 10. The backlight 50 is of a direct type used for, for example, a liquid crystal television, and the backlight 50 is formed by arranging the fiber lamp 10 on a back surface of a diffuser plate 51.

The diffuser plate 51 diffuses incident light from the back surface thereof to make an intensity distribution uniform. In terms of transparency, workability, heat resistance and the like, examples of a material of the diffuser plate 51 include a thermoplastic resin such as polycarbonate (PC), polyethylene terephthalate (PET), polyethylene naphthalate (PEN), polystyrene (PS), polyether sulfone (PES) or cyclic amorphous polyolefin, multifunctional acrylate, multifunctional polyolefin, unsaturated polyester, an epoxy resin and the like. In particular, a material which is only slightly degraded by blue laser light or near-ultraviolet laser light is preferable. The diffuser plate 51 has, for example, a thickness of approximately 1 mm to 3 mm.

The fiber lamp 10 is bendable with a radius of curvature of approximately 2 cm to 3 cm. Therefore, instead of 10 to 20 fluorescent tubes used for a large liquid crystal television in related art, one fiber lamp 10 is folded in an accordion fashion is used, thereby the fiber lamp 10 is allowed to be arranged in substantially the same manner as the fluorescent tubes in related art.

Moreover, it is difficult to bend a backlight using a fluorescent tube or an LED in related art, because the fluorescent tube is made of glass, or a substrate of the LED is rigid. On the other hand, in the embodiment, even if the diffuser plate 51 is bent, the fiber lamp 10 is not broken, so the bendable backlight 50 is achievable.

Further, it is difficult for the fluorescent tube in related art to have a tube diameter of 1 mm or less, and a thinner line light source is desired in terms of optical design. In most cases, the diameter of the side-emitting fiber 20 is 1 mm or less, so optical design of the fiber lamp 10 for obtaining uniform illumination is easy.

Backlight; Side Surface Arrangement

FIG. 8 illustrates a configuration of another backlight 60 using the fiber lamp 10. The backlight 60 is of an edge light type used for, for example, a liquid crystal television, and the backlight 60 is formed by arranging the fiber lamp 10 on a side surface of a light guide plate 61.

As in the case of the diffuser plate 51, in terms of transparency, workability, heat resistance and the like, examples of a material of the light guide plate 61 include a thermoplastic resin such as polycarbonate, polyethylene terephthalate, polyethylene naphthalate, polystyrene, polyether sulfone or cyclic amorphous polyolefin, multifunctional acrylate, multifunctional polyolefin, unsaturated polyester, an epoxy resin and the like. The light guide plate 51 has, for example, a thickness of approximately 0.5 mm to 5 mm.

The side-emitting fiber 20 is arranged on each of long sides 61A and 61C from four sides 61A, 61B, 61C and 61D of the light guide plate 61. In the case where it is not necessary to emit light from short sides 61B and 61D, or in the case where light emission causes an inconvenience, a commonly-used waveguide fiber 62 may be arranged instead of the side-emitting fiber 20. The side-emitting fiber 20 and the commonly-used waveguide fiber 62 are spliced to each other by, for example, a fiber fusion splicing apparatus. The light source 30 is arranged at a corner 61E of the light guide plate 61. In addition, the side-emitting fibers 20 arranged on the long sides 61A and 61C are not necessarily connected to the commonly-used waveguide fiber 62, and the light source 30 may be arranged corresponding to each of the side-emitting fibers 20.

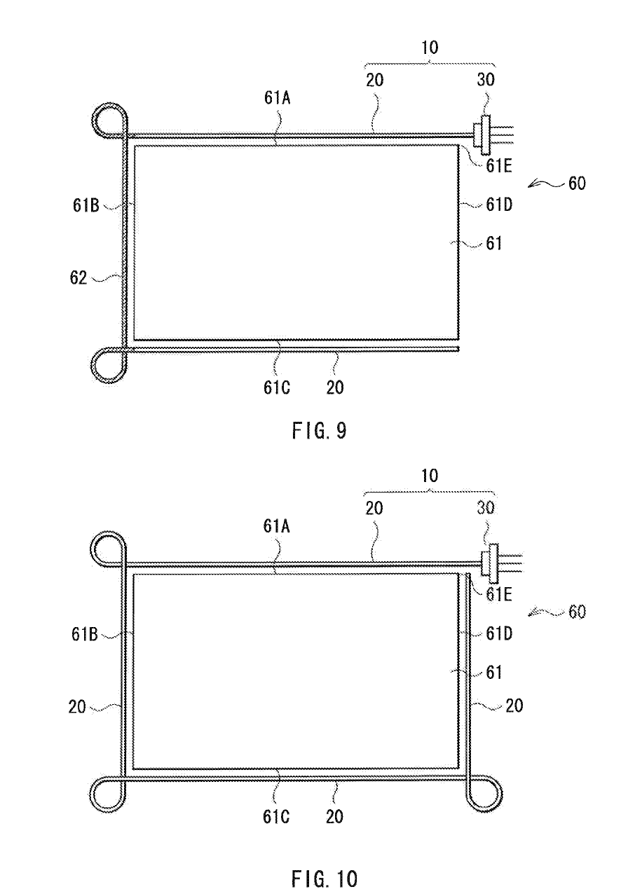

In addition, as illustrated in FIG. 8, the side-emitting fiber 20 or the commonly-used waveguide fiber 62 is desired to be bent along a corner of the light guide plate 61. In the case where it is difficult to bend the side-emitting fiber 20 or the commonly-used waveguide fiber 62 in such a manner, as illustrated in FIG. 9, the side-emitting fiber 20 or the commonly-used waveguide fiber 62 may be bent outward on extensions of the long sides 61A and 61C.

Moreover, as illustrated in FIG. 10, one side-emitting fiber 20 may be arranged on the four sides 61A, 61B, 61C and 61D of the light guide plate 61. When light is guided from four directions, more uniform illumination is allowed.

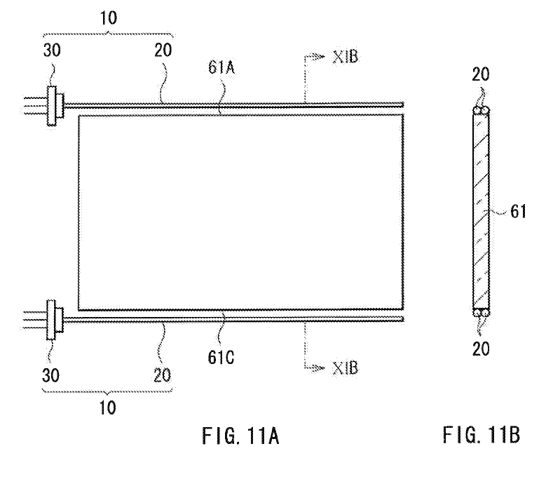

Further, in the case where higher luminance is necessary in a large liquid crystal television or the like, as illustrated in FIGS. 11A and 11B, two to several side-emitting fibers 20 may be arranged on each of the long sides 61A and 61C on the top and the bottom of the light guide plate 61. As the side-emitting fibers 20 each have a small diameter of 1 mm or less, the number of the side-emitting fibers 20 is allowed to be increased as far as the thickness of the light guide plate 61 permits.

In the case of the edge light type, it is desirable to arrange an optically designed reflective plate on a back surface of the light guide plate 61.

Backlight; Partial Drive

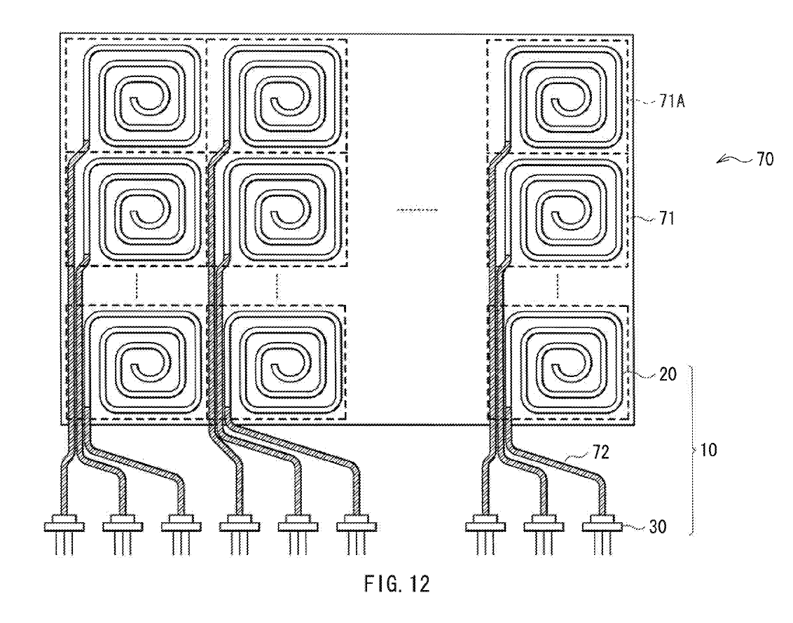

FIG. 12 illustrates a configuration of still another backlight 70 using the fiber lamp 10. In the backlight 70, a plurality of fiber lamps 10 are arranged on a back surface of a diffuser plate 71, and lighting-up of the plurality of fiber lamps 10 are controllable independently of one another.

The diffuser plate 71 are divided into a plurality of partial lighting regions 71 arranged in a matrix form. One side-emitting fiber 20 is arranged on each of the plurality of partial lighting regions 71A. For example, the side-emitting fiber 20 may be spirally bent, or folded in an accordion fashion. The light sources 30 are arranged, for example, below the diffuser plate 71 next to the side-emitting fibers 20. The side-emitting fibers 20 are connected to corresponding light sources 30 through commonly-used waveguide fibers 72, respectively. A backlight driving section (not illustrated) drives the light sources 30 by time division so as to perform the lighting operations of the partial lighting regions 71A independently.

In these backlights 50, 60 and 70, the fiber lamp 10 according to the embodiment is included, so heat is hardly generated in the side-emitting fiber 20. Therefore, a possibility that heat causes an issue in reliability of the diffuser plates 51 and 71, the light guide plate 61 and the like is allowed to be reduced.

Moreover, the thickness of a backlight in related art is limited to a few cm in the case where a light source is arranged on a back surface and a few mm in the case where the light source is arranged on a side surface. However, in the backlights 50, 60 and 70 according to the embodiment, the diameter of the side-emitting fiber 20 is 1 mm or less, so the thicknesses of the backlights 50, 60 and 70 are allowed to be reduced to 1 mm or less. Therefore, the backlights 50, 60 and 70 are extremely advantageous to further reduce the thickness of a liquid crystal display.

Liquid Crystal Display

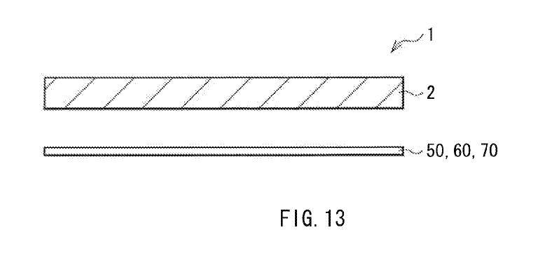

FIG. 13 schematically illustrates a liquid crystal display including one of such backlights 50, 60 and 70. A liquid crystal display 1 is, for example, a liquid crystal television or the like, and includes a liquid crystal display panel 2 and one of the backlights 50, 60 and 70 illuminating the liquid crystal display panel 2.

For example, the liquid crystal display panel 2 is formed by sealing a liquid crystal layer (not illustrated) between a TFT substrate (not illustrated) on which a TFT (Thin Film Transistor) and various kinds of drive circuits, a pixel electrode or the like are formed, and a facing substrate (not illustrated) on which a color filter, an opposed electrode or the like is formed. Polarization plates (not illustrated) are bonded to a light incident side and a light emission side of the liquid crystal display panel 2 so that polarization axes of the polarization plates are orthogonal to each other.

In the liquid crystal display 1, white light emitted from one of the backlights 50, 60 and 70 is applied to the liquid crystal display panel 2. The applied light is modulated based on image data in the liquid crystal display panel 2 so as to display an image.

In the liquid crystal display 1 according to the embodiment, the backlight 50, 60 or 70 according to the embodiment is included. Therefore, as the reliability of the backlights 50, 60 and 70 is improved, the liquid crystal display 1 is suitable for upsizing.

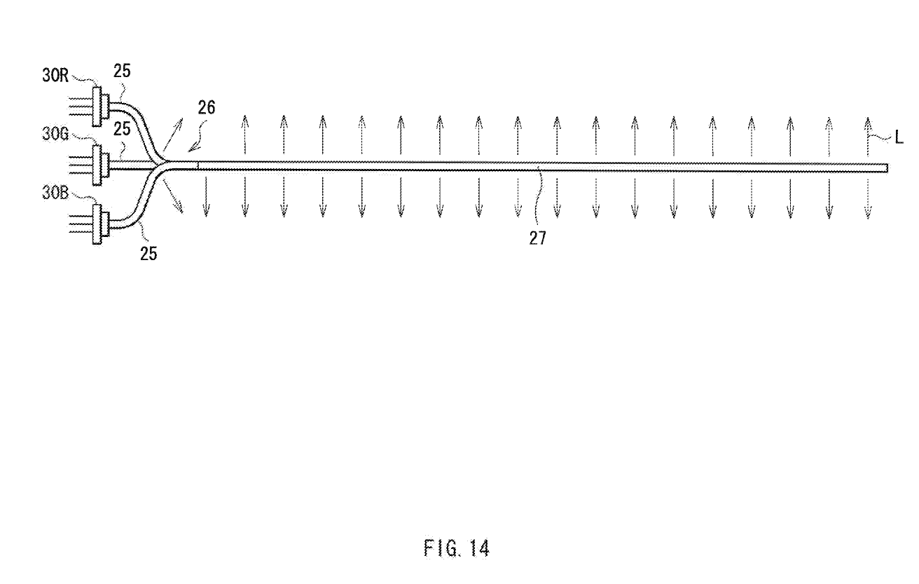

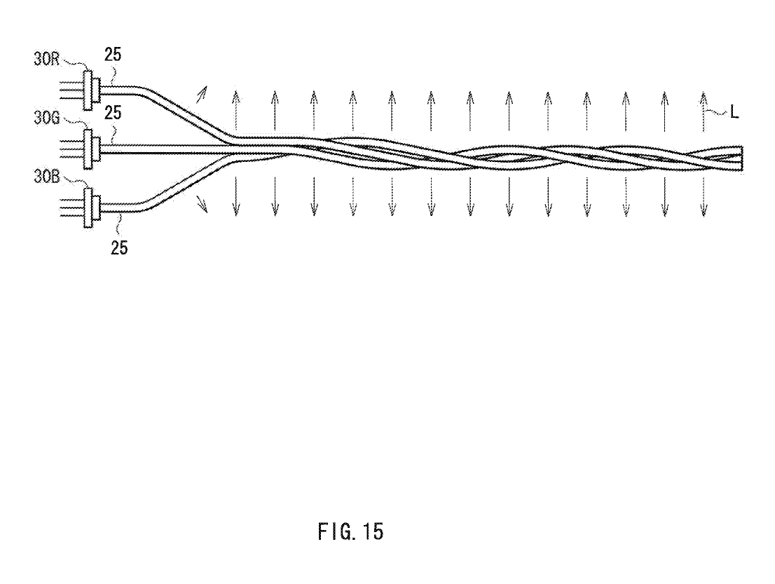

Although the present application is described referring to the embodiment and the modifications, the invention is not limited thereto, and may be variously modified. For example, as illustrated in FIG. 14 or 15, a white line light source is also achievable by arranging a light source 30R emitting red light, a light source 40G emitting green light and a light source 30B emitting blue light on ends on one side of three commonly-used side-emitting fibers 25, respectively. The commonly-used side-emitting fibers 25 each have the same configuration as the side-emitting fiber 20, except for the phosphor layer 40 is not included, and the cladding layer 22 does not include a phosphor. As illustrated in FIG. 14, these three commonly-used side-emitting fibers 25 may be bonded to one commonly-used side-emitting fiber 27 in an RGB multiplexing section 26. Moreover, in the case where the side-emitting fibers 25 are sufficiently thin (with a diameter of 0.5 mm or less), as illustrated in FIG. 25, three side-emitting fibers 25 may be stranded.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A fiber lamp comprising:
a side-emitting fiber including a core layer guiding light and a cladding layer arranged around the core layer, the cladding layer allowing light to be extracted from a surface of the cladding layer;
a light source arranged on one or both of a pair of end surfaces of the side-emitting fiber and emitting single-color light; and
a phosphor layer arranged on the surface of the cladding layer and including a red phosphor and a green phosphor.

2. The fiber lamp according to claim 1, wherein
the light source is a laser having an oscillation wavelength in a blue region, and
the phosphor layer includes the red phosphor, and the green phosphor.

3. The fiber lamp according to claim 1, wherein
the light source is a laser having an oscillation wavelength in a violet region, and
the phosphor layer includes the red phosphor, the green phosphor and a blue phosphor.

4. A fiber lamp comprising:
a side-emitting fiber including a core layer guiding light and a cladding layer arranged around the core layer, the cladding layer including a red phosphor and a green phosphor and allowing light to be extracted from a surface of the cladding layer; and
a light source arranged on one or both of a pair of end surfaces of the side-emitting fiber and emitting single-color light.

5. The fiber lamp according to claim 4, wherein
the light source is a laser having an oscillation wavelength in a blue region, and
the cladding layer includes the red phosphor and the green phosphor.

6. The fiber lamp according to claim 4, wherein
the light source is a laser having an oscillation wavelength in a violet region, and
the cladding layer includes the red phosphor, the green phosphor and a blue phosphor.

7. A backlight comprising:
a diffuser plate; and
a fiber lamp arranged on a back surface of the diffuser plate,
wherein the fiber lamp includes:
a side-emitting fiber including a core layer guiding light and a cladding layer arranged around the core layer, the cladding layer allowing light to be extracted from a surface of the cladding layer,
a light source arranged on one or both of a pair of end surfaces of the side-emitting fiber and emitting single-color light, and
a phosphor layer arranged on the surface of the cladding layer and including a red phosphor and a green phosphor.

8. A backlight comprising:
a diffuser plate; and
a fiber lamp arranged on a back surface of the diffuser plate,
wherein the fiber lamp includes:
a side-emitting fiber including a core layer guiding light and a cladding layer arranged around the core layer, the cladding layer including a red phosphor and a green phosphor and allowing light to be extracted from a surface of the cladding layer, and
a light source arranged on one or both of a pair of end surfaces of the side-emitting fiber and emitting single-color light.

9. The backlight according to claim 7, wherein
the diffuser plate is divided into a plurality of partial lighting regions, and the side-emitting fibers are arranged on the plurality of partial lighting regions, respectively, and the side-emitting fibers are connected to corresponding light sources through waveguide fibers, respectively.

10. The backlight according to claim 8, wherein
the diffuser plate is divided into a plurality of partial lighting regions, and the side-emitting fibers are arranged on the plurality of partial lighting regions, respectively, and the side-emitting fibers are connected to corresponding light sources through waveguide fibers, respectively.

11. A backlight comprising:
a light guide plate; and
a fiber lamp arranged on a side surface of the light guide plate,
wherein the fiber lamp includes:
a side-emitting fiber including a core layer guiding light and a cladding layer arranged around the core layer, the cladding layer allowing light to be extracted from a surface of the cladding layer,
a light source arranged on one or both of a pair of end surfaces of the side-emitting fiber and emitting single-color light, and
a phosphor layer arranged on the surface of the cladding layer and including a red phosphor and a green phosphor.

12. A backlight comprising:
a light guide plate; and
a fiber lamp arranged on a side surface of the light guide plate,
wherein the fiber lamp includes:
a side-emitting fiber including a core layer guiding light and a cladding layer arranged around the core layer, the cladding layer including a red phosphor and a green phosphor and allowing light to be extracted from a surface of the cladding layer, and
a light source arranged on one or both of a pair of end surfaces of the side-emitting fiber and emitting single-color light.

13. A liquid crystal display comprising:
a liquid crystal display panel; and
a backlight,
wherein the backlight includes a diffuser plate and a fiber lamp arranged on a back surface of the diffuser plate, and
the fiber lamp includes:
a side-emitting fiber including a core layer guiding light and a cladding layer arranged around the core layer, the cladding layer allowing light to be extracted from a surface of the cladding layer,
a light source arranged on one or both of a pair of end surfaces of the side-emitting fiber and emitting single-color light, and
a phosphor layer arranged on the surface of the cladding layer and including a red phosphor and a green phosphor.

14. A liquid crystal display comprising:
a liquid crystal display panel; and
a backlight,
wherein the backlight includes a diffuser plate and a fiber lamp arranged on a back surface of the diffuser plate, and
the fiber lamp includes:
a side-emitting fiber including a core layer guiding light and a cladding layer arranged around the core layer, the cladding layer including a red phosphor and a green phosphor and allowing light to be extracted from a surface of the cladding layer, and
a light source arranged on one or both of a pair of end surfaces of the side-emitting fiber and emitting single-color light.

15. A liquid crystal display comprising:
a liquid crystal display panel; and
a backlight,
wherein the backlight includes a light guide plate and a fiber lamp arranged on a side surface of the light guide plate, and
the fiber lamp includes:
a side-emitting fiber including a core layer guiding light and a cladding layer arranged around the core layer, the cladding layer allowing light to be extracted from a surface of the cladding layer,
a light source arranged on one or both of a pair of end surfaces of the side-emitting fiber, and emitting single-color light, and
a phosphor layer arranged on the surface of the cladding layer and including a red phosphor and a green phosphor.

16. A liquid crystal display comprising:
a liquid crystal display panel; and
a backlight,
wherein the backlight includes a light guide plate and a fiber lamp arranged on a side surface of the light guide plate, and
the fiber lamp includes:
a side-emitting fiber including a core layer guiding light and a cladding layer arranged around the core layer, the cladding layer including a red phosphor and a green phosphor and allowing light to be extracted from a surface of the cladding layer, and
a light source arranged on one or both of a pair of end surfaces of the side-emitting fiber and emitting single-color light.
